(19) United States
(12) Patent Application Publication
(10) Pub. No.: US 2015/0002961 A1
(43) Pub. Date: Jan. 1, 2015

(54) SCISSOR MAGNETIC SENSOR HAVING A BACK EDGE SOFT MAGNETIC BIAS STRUCTURE

(71) Applicant: HGST Netherlands B.V., Amsterdam (NL)

(72) Inventors: Christopher D. Keener, San Jose, CA (US); Quang Le, San Jose, CA (US); David J. Seagle, Morgan Hill, CA (US); Neil Smith, San Jose, CA (US); Petrus A. Van Der Heijden, Cupertino, CA (US)

(21) Appl. No.: 13/928,307

(22) Filed: Jun. 26, 2013

(51) Int. Cl. G11B 5/147; G11B 5/31

(52) U.S. Cl. CPC G11B 5/147; G11B 5/3163
USPC 360/235.4; 204/192.34

(57) ABSTRACT

A scissor type magnetic sensor having a soft magnetic bias structure located at a back edge of the sensor stack. The sensor stack includes first and second magnetic free layers that are anti-parallel coupled across a non-magnetic layer sandwiched there-between. The soft magnetic bias structure has a length as measured perpendicular to the air bearing surface that is greater than its width as measured parallel with the air bearing surface. This shape allows the soft magnetic bias structure to have a magnetization that is maintained in a direction perpendicular to the air bearing surface and which allows the bias structure to maintain a magnetic bias field for biasing the free layers of the sensor stack.

### FIELD OF THE INVENTION

The present invention relates to magnetic data recording and more particularly to a scissor type magnetic sensor having a back edge soft magnetic biasing structure.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor or a Tunnel Junction Magnetoresisive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the adjacent magnetic media.

As the need for data density increases there is an ever present need to decrease the size of a magnetic read sensor. With regard to linear data density along a data track, this means reducing the gap thickness of a magnetic sensor. Currently used sensors, such as the GMR and TMR sensors discussed above, typically require 4 magnetic layers, 3 ferromagnetic (FM) and 1 antiferromagnetic (AFM) layer, along with additional nonmagnetic layers. Only one of the magnetic layers serves as the active (or free) sensing layer. The remaining “pinning” layers, while necessary, nonetheless consume a large amount of gap thickness. One way to overcome this is to construct a sensor as a “scissor” sensor that uses only two magnetic “free” layers without additional pinning layers, thus potentially reducing gap thickness to a significant degree. However, the use of such a magnetic sensor results in design and manufacturing challenges. One challenge presented by such as structure regards proper magnetic biasing of the two free layers of the sensor.

### SUMMARY OF THE INVENTION

The present invention provides a magnetic read sensor having a sensor stack with first and second magnetic free layers. The sensor stack has a first edge located at an air bearing surface and a second edge opposite the first edge. The sensor also has a magnetically soft bias structure located adjacent to the second edge of the sensor stack and extending in a direction away from the air bearing surface.

The soft magnetic bias layer can be constructed of a material having a low coercivity and preferably having a high magnetization saturation (high Bs). To this end, the soft magnetic bias structure can be constructed of NiFe, NiFeMo, CoFe, CoNiFe, or alloys thereof. For example, the soft magnetic bias structure can be constructed of NiFe having 50-60 atomic percent Fe or about 55 atomic percent Fe or CoFe.

In addition, the use of a soft magnetic bias layer, rather than using a magnetically hard material, can potentially improve magnetic biasing of the free magnetic layers of the magnetic sensor. Process variations that would otherwise arise with the use of a hard magnetic bias structure can be mitigated by the use of a soft magnetic bias structure, providing for a sufficiently strong, magnetic bias field at the back edge of the scissor-type read sensor where it is needed.

The use of a soft magnetic bias structure is made possible by controlling the shape of the bias structure in such a manner that the soft magnetic bias structure does not become de-magnetized. This shape and a method for manufacturing a soft magnetic bias structure having such a shape will be discussed in greater detail herein below.

These and other features and advantages of the invention will be apparent upon reading of the following detailed description of preferred embodiments taken in conjunction with the figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an air bearing surface view of a scissor type magnetic read sensor;

FIG. 4 is a top down, cross sectional view of the scissor type magnetic read sensor of FIG. 3, as seen from line 4-4 of FIG. 3.

FIG. 5 is a top down, exploded, schematic view of a portion of the read element of FIG. 3;

FIGS. 6-24 show a magnetic sensor in various intermediate stages of manufacture in order to illustrate a method of manufacturing a magnetic sensor according to an embodiment of the invention;

FIG. 25 is a schematic view of a prior art scissor type sensor employing a magnetically hard bias layer at the back edge of the sensor;

FIGS. 26 and 27 are schematic views illustrating bias structure designs using a magnetically soft magnetic material as a biasing layer for a scissor-type read sensor;

FIG. 28 is a side cross sectional view of a sensor as viewed from line 28-28 of FIG. 3; and

FIG. 29 is a side cross sectional view of a sensor according to another embodiment.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

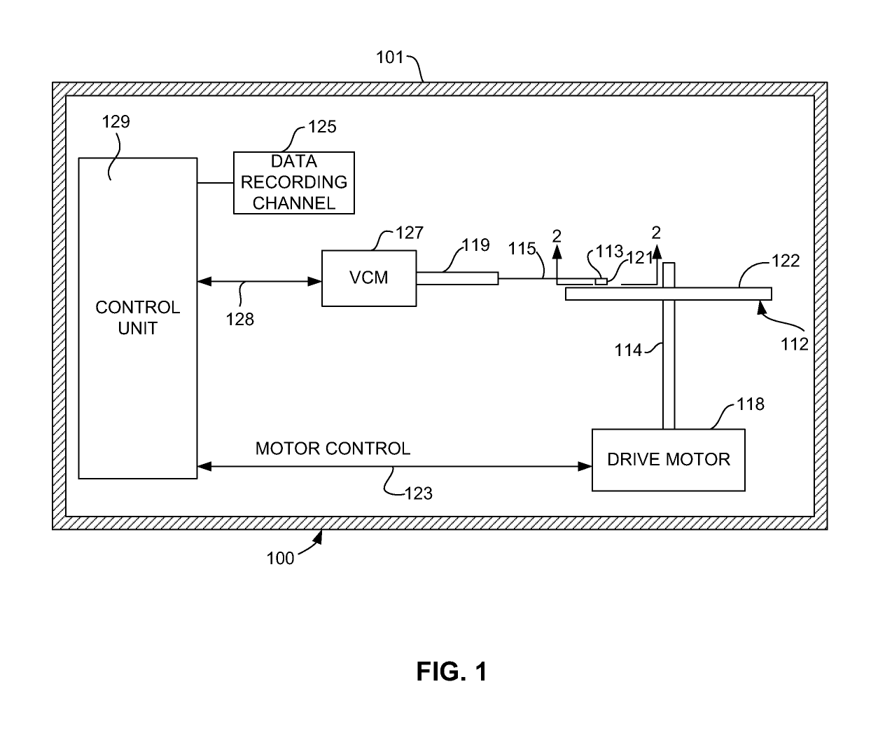

Referring now to FIG. 1, there is shown a disk drive 100 embodying this invention. The disk drive 100 includes a housing 101. At least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves I in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

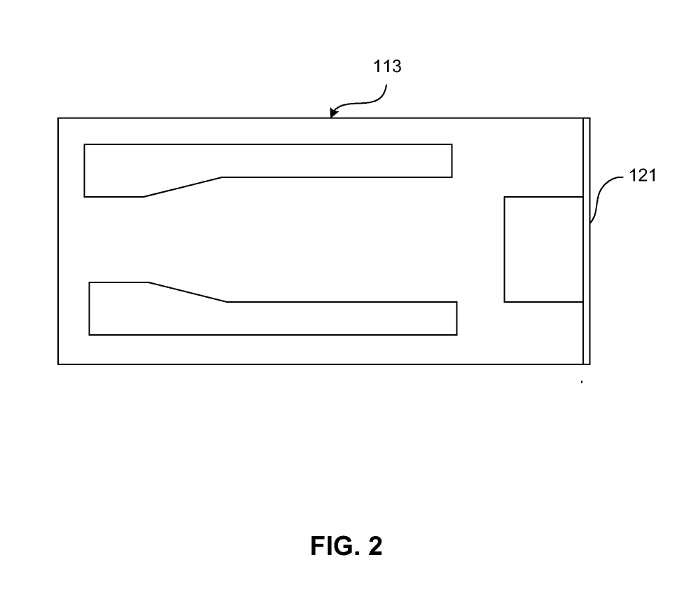

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

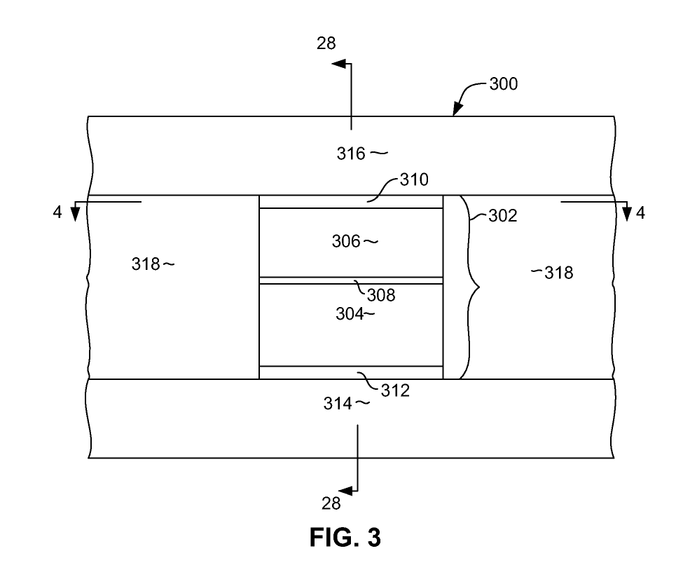

FIG. 3 shows a view of a magnetic read head 300 according to a possible embodiment of the invention as viewed from the air bearing surface. The read head 300 is a scissor type magnetoresistive sensor having a sensor stack 302 that includes first and second free layers 304, 306 that are anti-parallel coupled across a non-magnetic layer 308 that can be a non-magnetic, electrically insulating barrier layer such as MgOx or an electrically insulating spacer layer such as AgSn. A capping layer structure 310 can be provided at the top of the sensor stack 302 to protect the layers of the sensor stack during manufacture. The sensor stack 302 can also include a seed layer structure 312 at its bottom to promote a desired grain growth in the above formed layers.

The first and second magnetic layers 304, 306 can be constructed of multiple layers of magnetic material. For example, the first magnetic layer 304 can be constructed of: a layer of Ni—Fe; a layer of Co—Hf deposited over the layer of Ni—Fe; a layer of Co—Fe—B deposited over the layer of Co—Hf; and a layer of Co—Fe deposited over the layer of Co—Fe—B. The second magnetic layer 306 can be constructed of: a layer of Co—Fe; a layer of Co—Fe—B deposited over the layer of Co—Fe; a layer of Co—Hf deposited over the layer of Co—Fe—B; and a layer of Ni—Fe deposited over the layer of Co—Hf. The capping layer structure 310 can also be constructed as a multi-layer structure and can include first and second layers of Ru with a layer of Ta sandwiched there-between. The seed layer structure 312 can include a layer of Ta and a layer of Ru formed over the layer of Ta.

The sensor stack 302 is sandwiched between leading and trailing magnetic shields 314, 316, each of which can be constructed of a magnetic material such as Ni—Fe, of a composition having a high magnetic permeability (μ) to provide effective magnetic shielding.

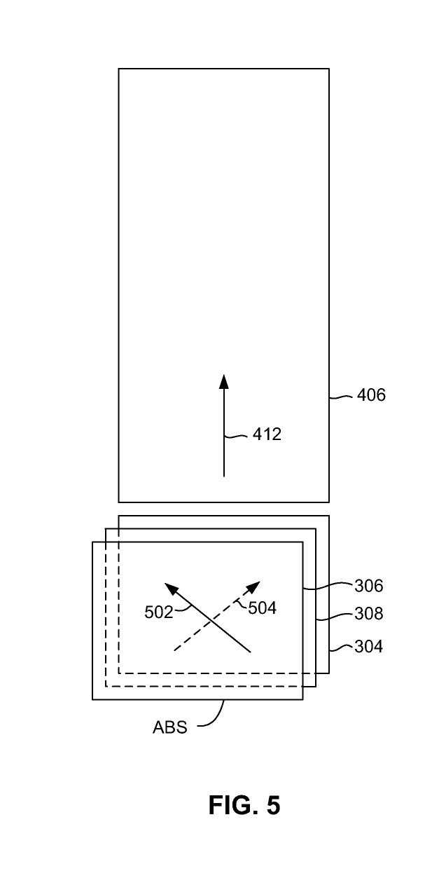

During operation, a sense current or voltage is applied across the sensor stack 302 in a direction perpendicular to the plane of the layers of the sensor stack 302. The shields 314, 316 can be constructed of an electrically conductive material so that they can function as electrical leads for supplying this sense current or voltage across the sensor stack 302. The electrical resistance across the sensor stack 302 depends upon direction of magnetization of the free magnetic layers 304, 306 relative to one another. The closer the magnetizations of the layer 304, 306 are to being parallel to one another the lower the resistance will be, and, conversely, the closer the magnetizations of the layers 304, 306 are to being anti-parallel to one another the higher the resistance will be. Since the orientations of the magnetizations of the layers 304, 306 are free to move in response to an external magnetic field, this change in magnetization direction and resulting change in electrical resistance can be used to detect a magnetic field such as from an adjacent magnetic media (not shown in FIG. 3). The relative orientations of the magnetizations of the layers 304, 306 will be described in greater detail below with reference to FIG. 5. If the non-magnetic layer 308 is an electrically insulating barrier layer, then the sensor operates based on the spin dependent tunneling effect of electrons tunneling through the barrier layer 308. If the layer 308 is an electrically conductive spacer layer, then the change in resistance results from spin dependent scattering phenomenon.

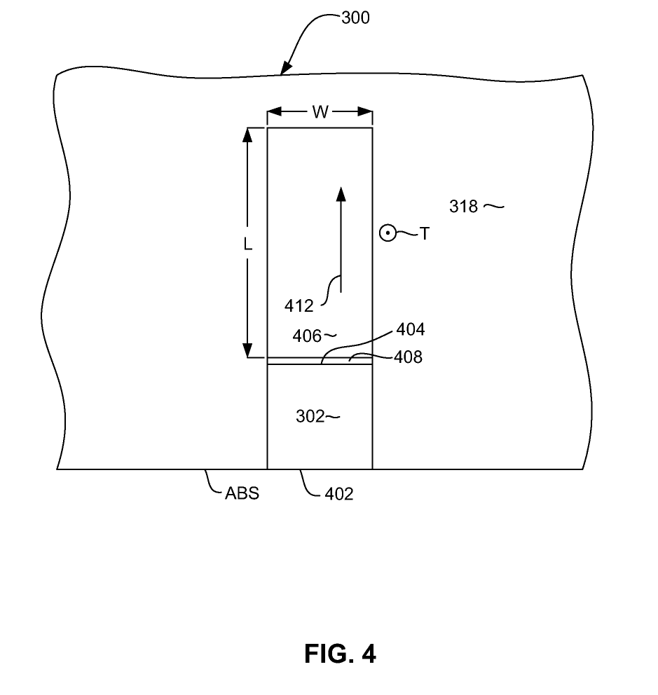

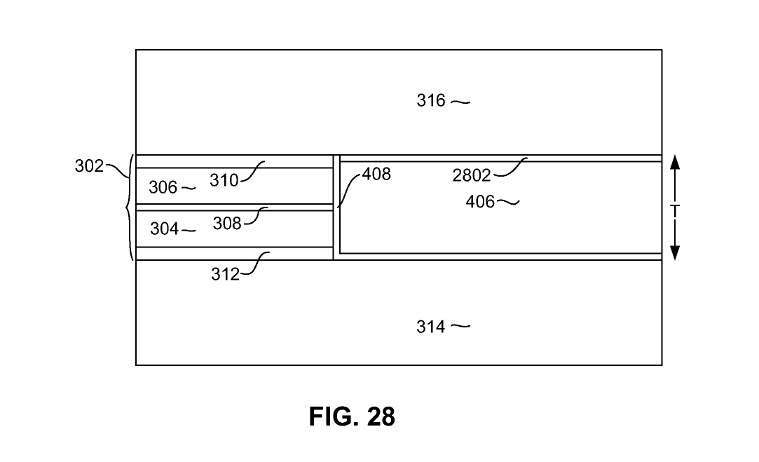

FIG. 4 shows a top down, cross sectional view as seen from line 4-4 of FIG. 3, and FIG. 28 shows a side cross sectional view as viewed from line 28-28 of FIG. 3. FIG. 4 shows the sensor stack having a front edge 402 that extends to the air bearing surface (ABS) and has a back edge 404 opposite the front edge 402. The distance between the front edge 402 and back edge 404 defines the stripe height of the sensor 300. As can be seen in FIG. 4 the sensor 300 also includes a soft magnetic bias structure 406 that extends from the back edge of the sensor stack 404 in a direction away from the ABS. The soft magnetic bias structure 406, constructed of a soft magnetic material having a relatively low coercivity. The term soft as used herein refers to a magnetic material that has a low magnetic coercivity that does not inherently maintain a magnetic state as a result of its grain structure as a hard, or high coercivity, magnetic material would do. This distinction will be further discussed herein below. The soft magnetic bias structure 406 is separated from the sensor stack 302 by a non-magnetic, electrically insulating layer such as alumina 408. In addition, a non-magnetic, decoupling layer 2802 can be provided at the top of the bias structure to separate the bias structure 406 from the upper shield 316 as shown in FIG. 28.

As discussed above, the soft magnetic bias structure 406 is constructed of a soft magnetic material (i.e. a material having a low magnetic coercivity). To this end, the soft magnetic bias structure 406 can be constructed of a material such as NiFe, NiFeMo, CoFe, CoNiFe, or alloys thereof. More preferably, for optimal magnetic biasing the magnetic bias structure 406 is constructed of a high magnetization saturation (high Bs) material, for example, NiFe having 50 to 60 atomic percent or about 55 atomic percent Fe or CoFe.

With continued reference to FIG. 4, it can be seen that the soft magnetic bias structure 406 has a length L measured in the direction perpendicular to the ABS that is significantly larger than its width W as measured in a direction parallel to the ABS. The soft magnetic bias structure 406 also has a thickness T (FIG. 28) that is measured perpendicular to both the width W and the length L and parallel with the air bearing surface. Preferably, the bias structure 406 has sides that are aligned with the sides of the sensor stack 302 so that the width W of the soft-bias structure is equal to the width of the sensor stack. This can be achieved by a self aligned manufacturing process that will be described in greater detail herein below.

The soft magnetic bias structure 406 has a shape that causes the magnetization 412 to remain oriented in the desired direction perpendicular to the air bearing surface, even in spite of the soft magnetic properties of the material of which it is constructed. During manufacture of the sensor 300, the magnetization of the bias structure 406 can be set in a desired direction perpendicular to the ABS (e.g. away from the ABS) as indicated by arrow 412, and the shape of the soft magnetic bias structure 406 causes this magnetization 412 to remain in the desired direction in the finished magnetic sensor.

The soft magnetic bias structure 406 is constructed of a material having an intrinsic exchange length lₑₓ, and the dimensions of the soft magnetic bias structure 406 are preferably such that both the width W and thickness T are less than 10 times lₑₓ. The term the exchange length as used herein can be defined as lₑₓ=sqrt[A/(2pi*Ms*Ms)], where “Ms” is the saturation magnetization of the material, “A” is the exchange stiffness. In one embodiment, the soft magnetic bias structure 406 can be constructed of one or more of Co, Ni and Fe having an intrinsic exchange length lₑₓ of 4-5 nm, and has a width W that is less than 40 nm, and a thickness T that is less than 20 nm.

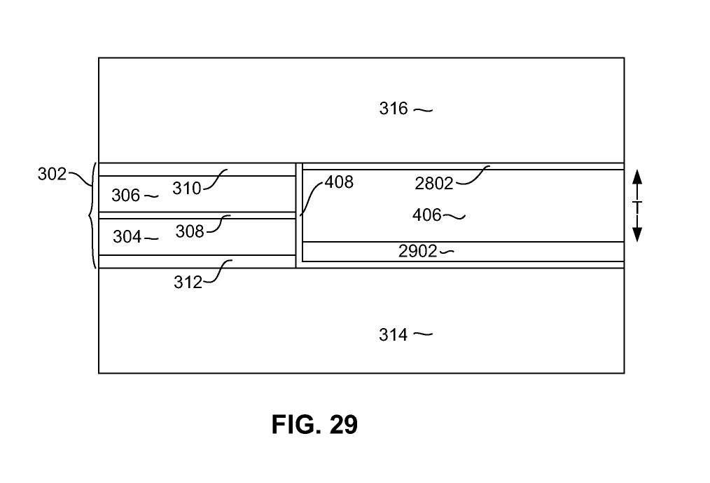

FIG. 29 shows a side, cross sectional view of an alternate embodiment of the magnetic sensor. Whereas, in FIG. 28 the bias structure 406 maintained its magnetization solely as a result of the above described shape, in FIG. 28 a layer of antiferromagnetic material 2902 is contacts and is exchange coupled with the bias layer 406. This exchange coupling provides additional stability by pinning the magnetization of the bias structure 406. Therefore, while the bias structure 406 is still a soft magnetic material, its magnetization can be pinned by the exchange coupling with the layer of antiferromagnetic material. The layer 2902 can be PtMn or IrMn, and is preferably IrMn.

FIG. 5 shows an exploded, top-down view of the magnetic layers 304, 306 with the non-magnetic layer 308 there-between. The presence of the non-magnetic layer 308 between the first and second magnetic layers 304, 306 causes the magnetic layers 304, 306 to be magnetostatically coupled with one another. In addition, the magnetic layers 304, 306 have a magnetic anisotropy that is parallel with the ABS, so that in the absence of a magnetic field 412 from the soft bias layer 406, the magnetizations of the layers 304, 306 would be oriented anti-parallel to one another and parallel with the ABS. However, the presence of the a bias field from the magnetization 412 of the bias layer 406 cants the magnetizations of the magnetic layers 304, 306 to a direction that is not parallel with the ABS (i.e. orthogonal to one another). The directions of magnetization of the magnetic layers 304, 306 are represented by arrows 502, 504, with the arrow 502 representing the direction of magnetization of the layer 304 and the arrow 504 representing the direction of magnetization of the layer 306. However, the magnetizations 502, 504, can move relative to one another in response to a magnetic field, such as from a magnetic media. As discussed above, this change in the directions of magnetizations 502, 504 relative to one another changes the electrical resistance across the barrier layer 308, and this change in resistance can be detected as a signal for reading magnetic data from a media such as the media 112 of FIG. 1. The closer the magnetizations 502, 504 are to being parallel with one another, the lower the resistance across the layers 304, 308, 306 will be. Conversely, the closer the magnetizations 502, 504 are to being anti-parallel, the higher the resistance will be. As seen in 5, the bias field from the magnetization 412 of the soft-bias structure 406 deflects the magnetizations to an orientation where they are essentially orthogonal to one another in the absence of an external magnetic field. A magnetic field from a magnetic medium causes the magnetizations 502, 504 to deflect either toward or away from the air bearing surface (ABS). The orthogonal orientation of the magnetizations 502, 504 causes the resulting signal to be in a substantially linear region of the transfer curve for optimal signal processing.

Because sensor 300 has its soft bias structure 402 at the back edge of the sensor stack 302, the sensor 300 does not require magnetic bias structures at its sides. Therefore, with reference again to FIG. 3, the space at either side of the sensor stack 302 between the shields 314, 316 can be filled with a non-magnetic, electrically insulating material 318 such as alumina, SiN, Ta₂O₅, or combination thereof. This electrically insulating fill layer provides good insulation assurance against any electrical shunting between the shields 314, 316. This however does not preclude the use of bias structures, either magnetically soft or magnetically hard, at the sides of the sensor.

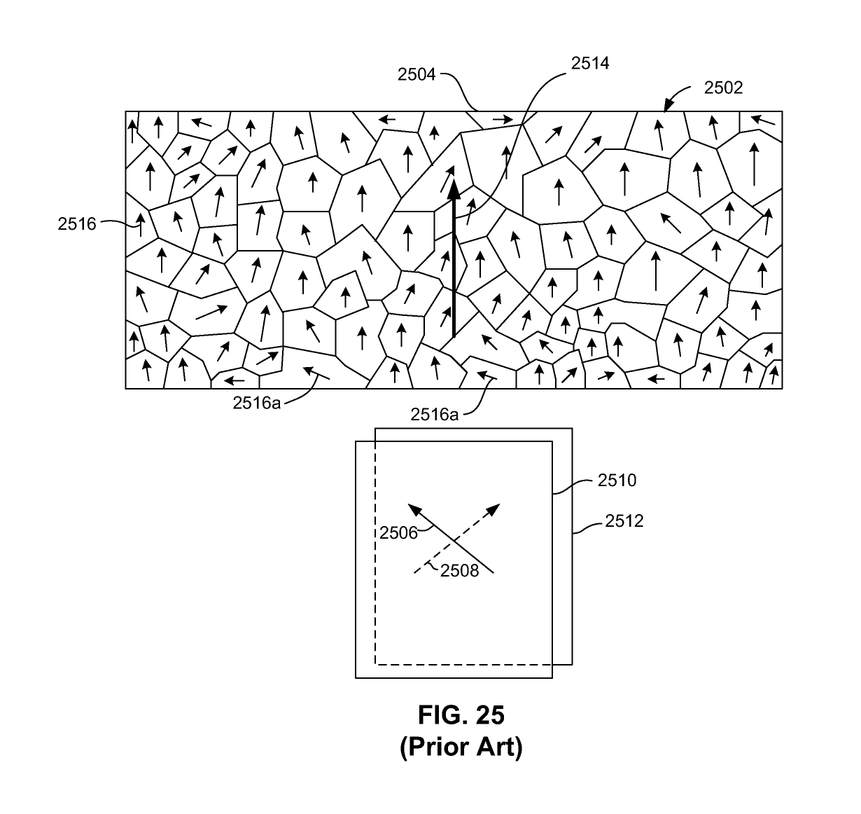

The advantages provided by a magnetic read sensor having a soft magnetic bias structure as described above can be better understood with reference to FIGS. 25-27. FIG. 25 schematically illustrates a sensor 2502 having a prior art hard magnetic bias structure 2504. The magnetization vectors 2506, 2508 of the two magnetic free-layers 2510, 2512 are at approximately orthogonal angles, and this arrangement is maintained by a vertical magnetic field 2514 from the “hard-bias” layer 2504, which is a high coercivity, “permanent” (or magnetically “hard”) magnetic material such as CoPt.

Because the bias structure 2504 maintains its magnetization by virtue of its hard magnetic properties, it can be made much wider than the width of the sensor. This allows for increased bias field, and also reduces the criticality of lateral alignment with the sensor layers 2510, 2512. This hard-bias layer 2504 maintains its vertical magnetization orientation, and thus constant vertical magnetic bias field 2514, by its intrinsic nature as a hard magnetic material whose magnetization will not be altered either by internal demagnetization, or the resultant magnetic fields arising from the recording media or that from the scissor sensor itself. The mean direction of the magnetization (here in the vertical direction) of the hard magnetic material can be set by a one-time application of an external magnetic field exceeding the coercivity of the hard magnetic material (typically a few kOe). However, for most practically available hard magnetic materials (e.g., CoPt), the magnetization orientations of the individual magnetic grains (5-10 nm diameter) predominantly follow the crystal anisotropy axes of the individual grains, (which are somewhat random/isotropic), and inter-granular exchange forces between grains is insufficiently strong relative crystal anisotropy to align the individual grain magnetizations in one direction. Even if on average the grain magnetization orientation is well aligned in the vertical direction as indicated by individual arrows 2516 (not all of which are labeled in FIG. 25 for purposes of clarity) individual grains can be oriented in some other direction that is not perpendicular to the air bearing surface. Since it is those few grains closest to the back edge of the scissor sensor which play the largest role in determining the bias field to the scissor sensor, there exists the likelihood of substantial device-to device variation of the bias field, and hence variation in the bias magnetization configuration of the free-layers. For example, although the magnetizations 2516 of the grains are on average oriented perpendicular to the ABS as shown, some of the grains at the edge can be oriented in a direction that is not perpendicular to the ABS as indicated by arrows 2516a.

Another challenge presented by the use of a hard magnetic bias structure 2504 arises out of practical considerations related to the formation of such a bias structure 2504 in an actual sensor. As discussed above, hard magnetic properties needed to maintain magnetization arise from the proper material film growth of the bias structure 2504. In order for this to occur, the hard-bias structure 2504 must generally be grown up from a proper seed layer that is flat and uniform. However, as a practical matter, there will inevitably be some topography variation at the back edge of the sensor. This can result in poor growth and poor magnetic properties (e.g., low coercivity) in the bias structure 2504 at the back edge of the sensor, which is the very location at which good magnetic properties are most important. This, therefore, further increases the likelihood of device to device variation in free layer biasing.

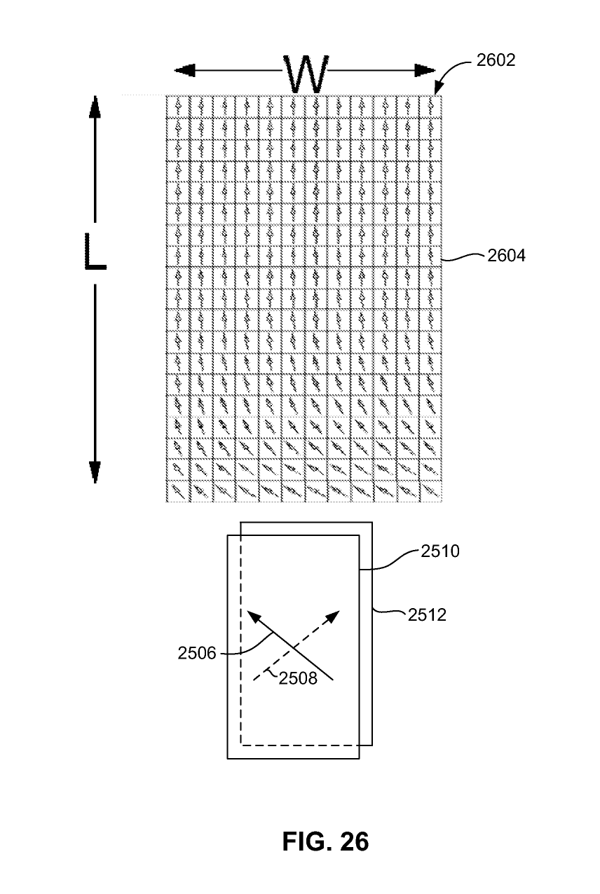

FIG. 26, on the other hand, illustrates a magnetic sensor 2602 having a soft magnetic bias structure 2604 that does not take advantage of the unique shape configurations discussed above with reference to FIG. 4. In the sensor of FIG. 26, the bias structure 2604 is notably wider than the sensor, somewhat similar in this particular respect to the hard bias structure 2504 of FIG. 25. As discussed above, making the bias structure relatively wide allows more tolerance in lateral alignment of the bias structure and also can increase the bias field provided by the bias structure. Because the material is a soft magnetic material, the intergranular exchange interaction between grains of “soft” magnetic materials is strong relative to a weaker, residual crystal anisotropy, and the magnetization orientations of the individual grains prefers to locally align everywhere parallel to each other, essentially averaging out the discrete nature of the grains and materially resembling an ideal homogeneous material not subject to the detrimental randomness of grain variations in hard magnetic materials. However, even though the local magnetizations of neighboring grains tend to align highly parallel to one another, the direction of the magnetization in the soft bias layer is not solely and simply set by the one-time application of an external magnetic field, as described above with reference to a hard magnetic bias layer. In particular, once such a setting field is removed, self-demagnetizing fields tend to try and align the magnetization in the soft bias layer at or near surfaces and/or edges to preferentially lie in a direction tangential to the surface or edge. Therefore, as shown in FIG. 26, the “wide” soft bias layer's magnetization at its edge closest to the sensor layers 2510, 2512, will substantially deviate from the desired direction perpendicular to the ABS, causing a large reduction in the biasing field it provides on the sensor layers 2510, 2512 (less than that achievable using prior art hard-bias) and no longer maintaining a proper bias magnetization state for adequate functionality of the scissor sensor.

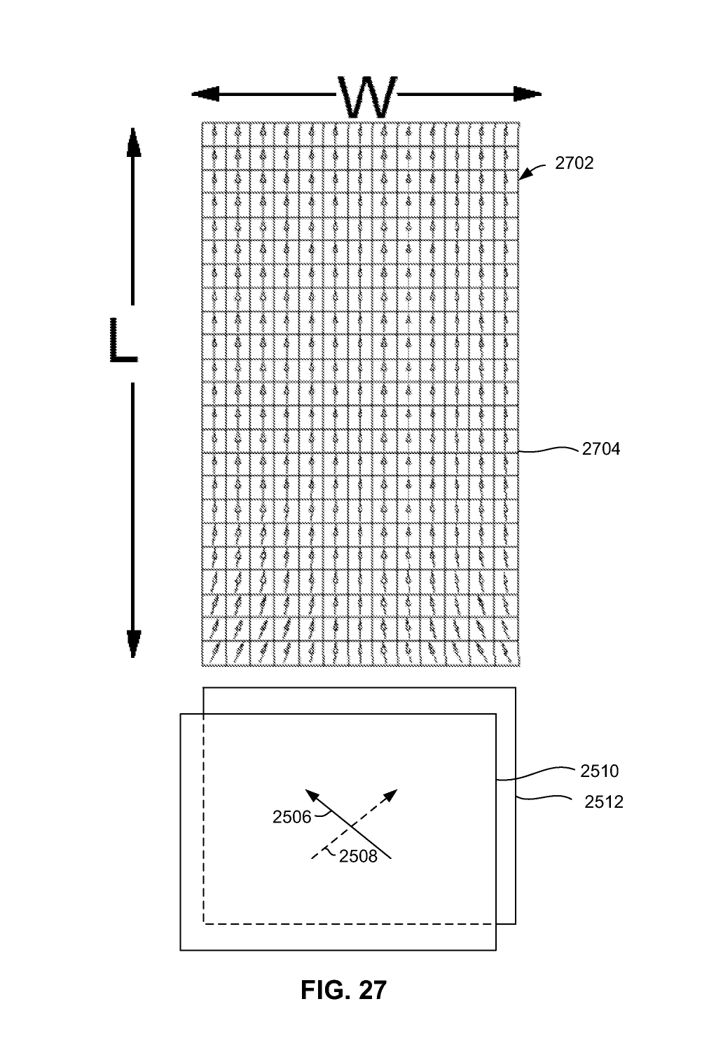

FIG. 27 on the other hand, shows a sensor 2702 that has a soft magnetic bias structure 2704 that has physical dimensions as described above with reference to FIG. 4 that allow the magnetization of the soft-bias layer to be well set in the desired direction perpendicular to the air bearing surface, even at the edge closest to the sensor layers 2510, 2512 and even in the presence of self demagnetizing fields from the soft-bias layer (or from the sensor layers 2510, 2512 or from the media).

To achieve the soft-bias magnetization condition illustrated in FIG. 27, there are two geometric/material constraints that should be met. Firstly, the vertical length L of the soft-bias layer should greatly exceed its width, i.e. L>>W. However, this condition may already exist as in the case of FIG. 26, and is thus insufficient to maintain the desired magnetic orientation. It is additionally desirable that the physical width W (and or soft-bias layer film thickness t) be further restricted in size relative to the intrinsic exchange length lₑₓ of the constituent magnetic material used for the soft bias layer, so that local intra-layer exchange stiffness favoring uniform (vertical) alignment of the magnetization exceeds the magnetostatic interactions that would otherwise cause the magnetization to “curl” away from the vertical direction and cause it to lie more tangential to the edges, as illustrated in FIG. 26. As discussed above, an approximately stated condition for exchange stiffness to dominate over magnetostatics is that the soft-bias layer's geometry additionally satisfy the constraint that W<10*lₑₓ and t<10*lₑₓ. For common material choices consisting of alloys of Co, Ni, and Fe, the exchange length lₑₓ is approximately 4-5 nm. Hence, soft-bias layers with geometries of practical interest, e.g., with W<40 nm and t<20 nm, satisfy these criteria.

In addition, the saturation magnetization Mₛ of the Co, Ni, Fe alloys that would be available choices for the soft-bias layer can be substantially larger than the saturation remanence Mᵣₛ of typical hard-bias material (e.g., CoPt). In fact, the saturation magnetization Mₛ of such alloys can be twice the saturation remanence Mᵣₛ of typical hard-bias materials (e.g., CoPt). Because of this, the bias field from the soft-bias layer can be as large or larger than that available from a hard-bias layer despite the approximate constraint that the soft-bias width satisfy W<40 nm, providing adequate and sufficient bias field strength to maintain the proper bias configuration of a scissor sensor.

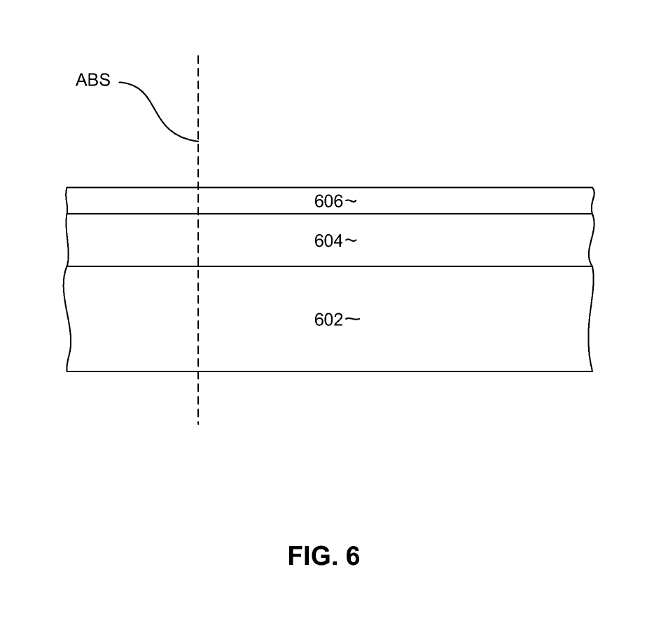

FIGS. 6-24 show a magnetic read sensor in various intermediate stages of manufacture in order to illustrate a method of manufacturing a magnetic sensor according to an embodiment of the invention. With particular reference to FIG. 6, a substrate 602 is constructed by methods familiar to those skilled in the art. The shield 602 can be a material such as NiFe and can be formed by electroplating. A series of sensor layers 604 are deposited full film over the shield 602. The series of sensor layers can include the layers 304, 306, 308, 312, 310 of the sensor stack 302 of FIG. 3. In addition, the sensor layers 604 can also include a layer such as carbon or diamond like carbon at its top to act as a chemical mechanical polishing stop layer (CMP stop). Then, a mask layer 606 is deposited over the sensor layers 604. The mask layer can include a layer of photoresist, but can also include other layers as well, such as one or more hard masks, a bottom anti-reflective coating, etc. The location of an intended air bearing surface plane is indicated by dashed line denoted ABS in FIG. 6 in order to show the relative orientation of the view of FIG. 6.

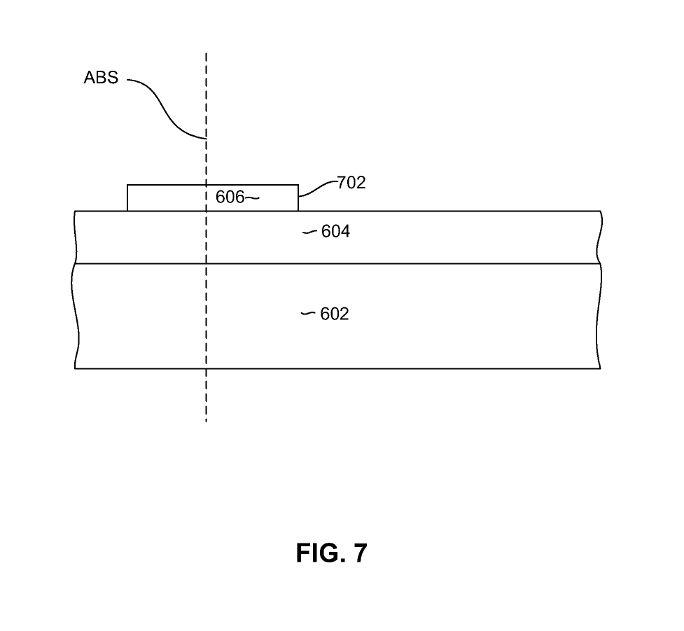

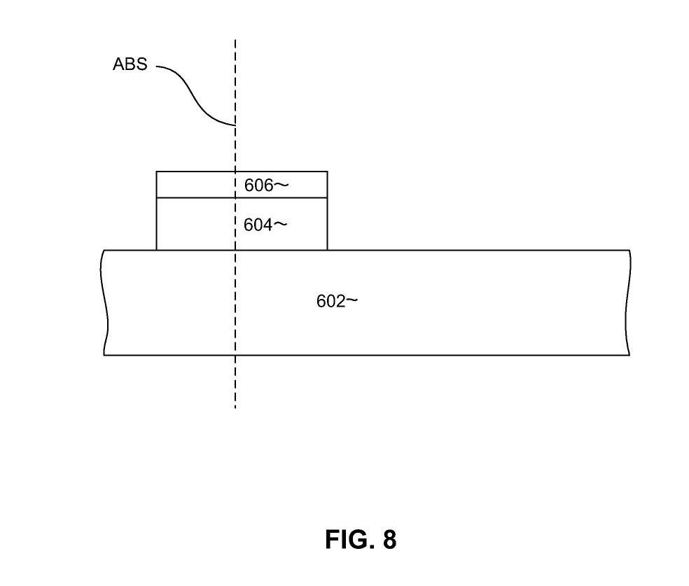

With reference now to FIG. 7, the mask layer 606 is patterned to form a mask having an edge 702 that is configured to define a back edge of the sensor (e.g. 404 in FIG. 4). An ion milling is then performed to remove portions of the sensor material that are not protected by the mask 606, leaving a structure as shown in FIG. 8.

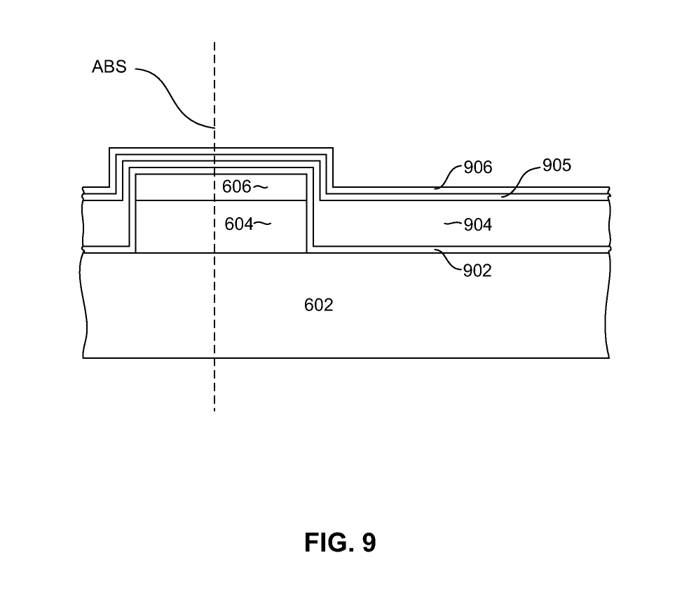

Then, with reference to FIG. 9, a thin, non-magnetic, electrically insulating layer 902 is deposited over the shield 602, sensor layer 604 and mask 606. The thin, non-magnetic, electrically insulating layer 902 can be alumina (Al₂O₃) and can be deposited by atomic layer deposition (ALD) or Si₃N₄ which can be deposited by ion beam deposition (IBD). Then, a layer of soft magnetic bias material 904 is deposited over the thin, non-magnetic, electrically insulating layer 902. The soft magnetic bias material 904 can be a material such as NiFe, NiFeMo, CoFe, CoNiFe or alloys thereof. More preferably, the layer 904 is NiFe having 50 to 60 or about 55 atomic percent Fe or CoFe. A capping 905 is deposited over the soft magnetic bias layer to break exchange coupling with the upper shield (not yet formed nor shown in FIG. 9). The capping layer 905 can be nonmagnetic material that can be either electrically conducting or electrically insulating. Then, a layer of material that is resistant to chemical mechanical polishing 906 can then be deposited over the capping layer material 905 to provide a CMP stop layer. This CMP stop layer 906 can be carbon or diamond like carbon (DLC) although other materials could also be used.

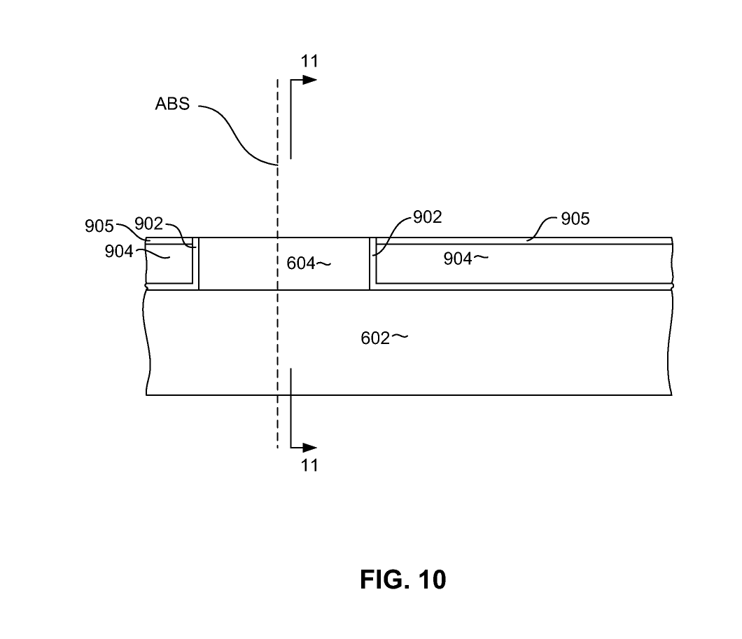

A liftoff and planarization process can then be performed to remove the mask 606 and form a flat surface as shown in FIG. 10. This process can include performing a wrinkle bake and chemical liftoff to remove the mask 606, performing a chemical mechanical polishing, and then performing a quick reactive ion etching to remove the CMP stop layer 906 (FIG. 9). As can be seen in FIG. 10, this results in a sensor 604 having a back edge and thin insulation layer 906 extending over the back edge of the sensor and over the shield 602. Also, a soft magnetic bias structure 904 extends from the back edge of the sensor 604, being separated from the sensor 604 and shield 602 by the insulation layer 906 and having the capping layer 905 formed there-over.

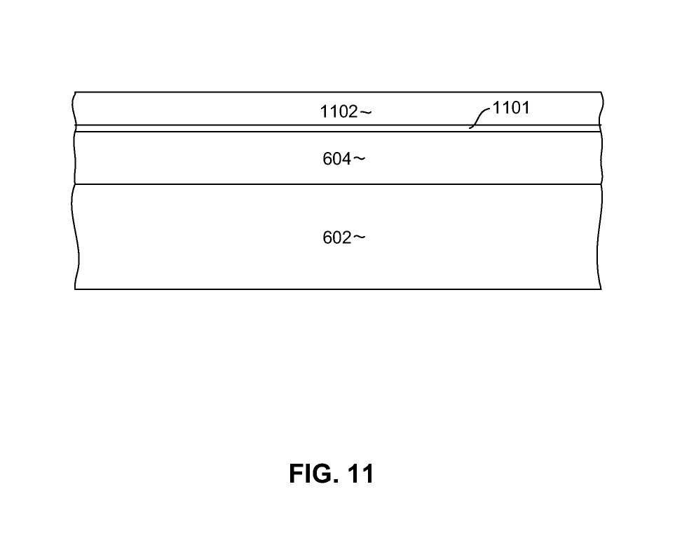

FIG. 11 shows a cross sectional view of a plane parallel with the ABS as seen from line 11-11 of FIG. 10. FIG. 11 shows the shield 602 and sensor layer 604. A second CMP stop layer (preferably carbon or diamond like carbon) 1101 and a second mask layer 1102 are deposited over the sensor layer 604. As with the previously described mask 606, this mask layer 1102 can include a layer of photoresist and may also include various other layers such as one or more hard masks, a bottom anti-reflective coating layer, etc.

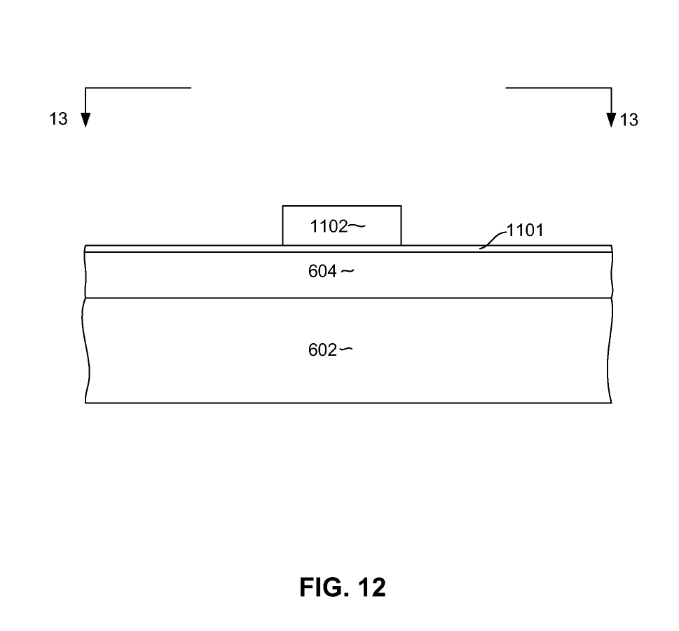

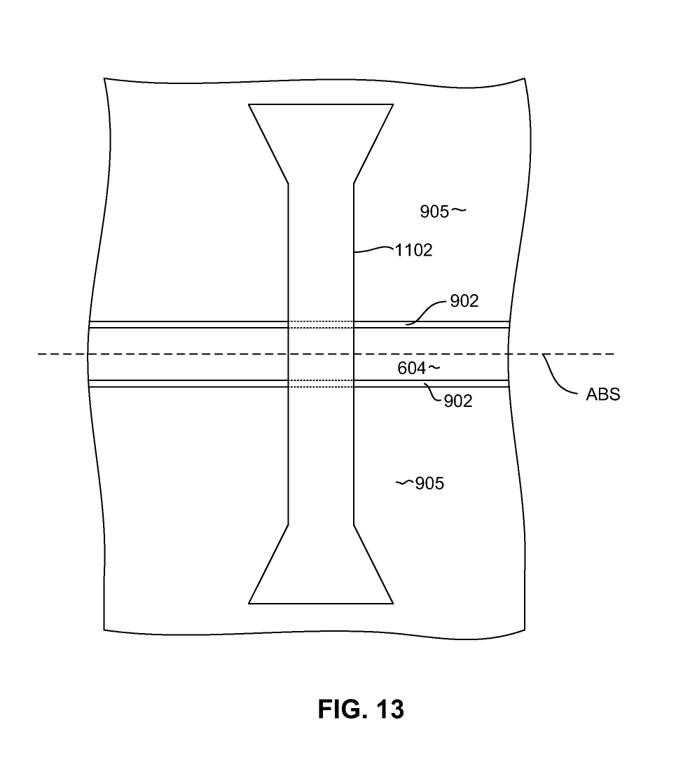

With reference to FIG. 12, the mask layer 1102 is photolithographically patterned to form a mask having edges that define a sensor width. The structure of the patterned mask 1102 can be seen with reference to FIG. 13 which shows a top-down view as seen from line 13-13 of FIG. 12. Structures shown in dotted line indicate structures that are located beneath the mask 1102 in FIG. 13.

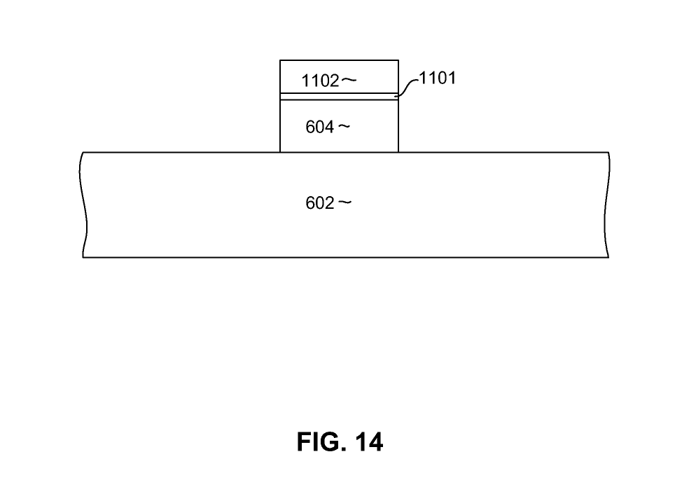

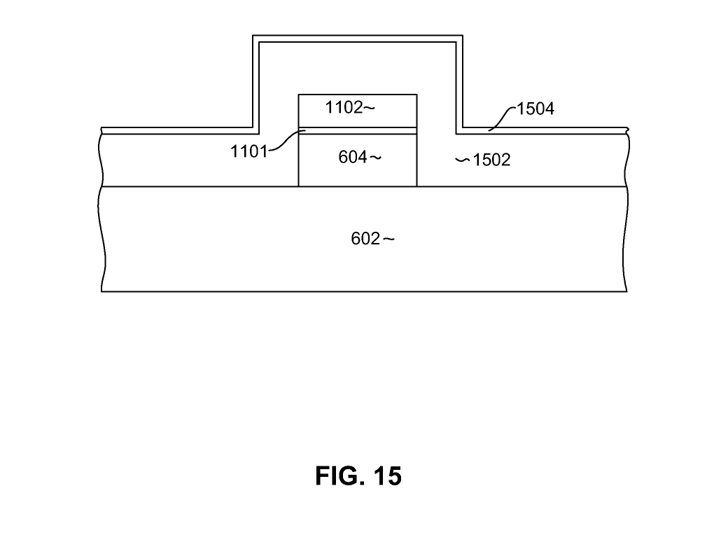

An ion milling can then be performed to remove material that is not protected by the mask 1102, leaving a structure shown in cross section in FIG. 14. Then, with reference to FIG. 15, an electrically insulating, non-magnetic fill layer such as alumina (Al₂O₃) is deposited about to the height of the sensor layer 604. Another CMP stop layer 1504, constructed of a layer that is resistant to chemical mechanical polishing such as carbon or diamond like carbon (DLC) can be deposited over the insulating fill layer 1502.

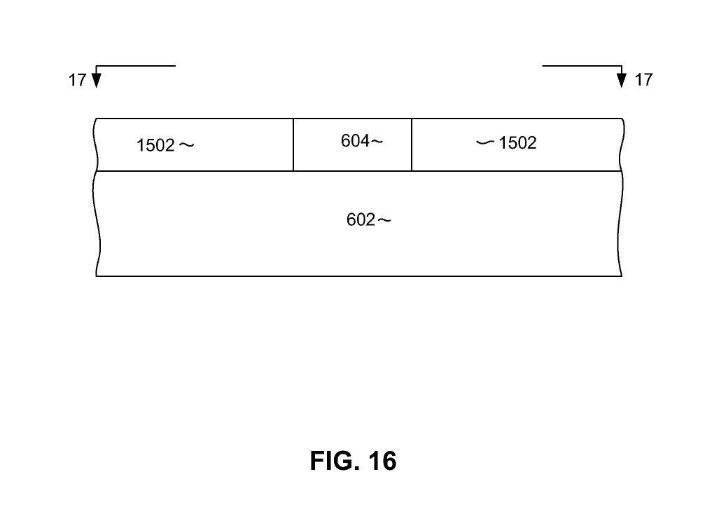

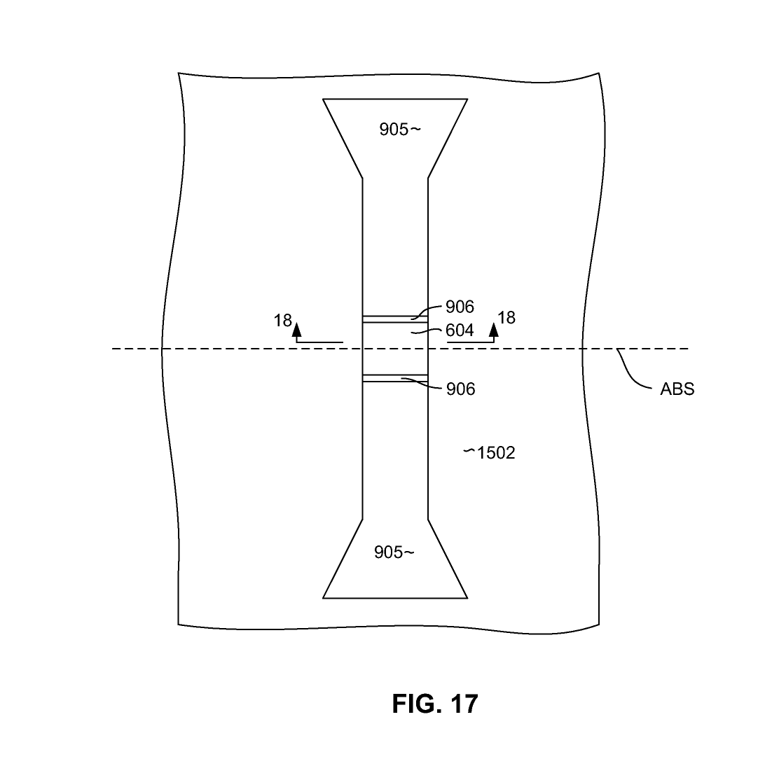

Another liftoff and planarization process can then be performed to remove the mask 604 and form a smooth planar structure as shown in FIG. 16. As before, this second liftoff and planarization can include performing a wrinkle bake and chemical liftoff to remove the mask and then performing a chemical mechanical polishing, followed by a quick reactive ion etching to remove the remaining CMP stop layers 1101, 1504 (FIG. 15). FIG. 17 shows a top-down view of the structure as seen from line 17-17 of FIG. 16.

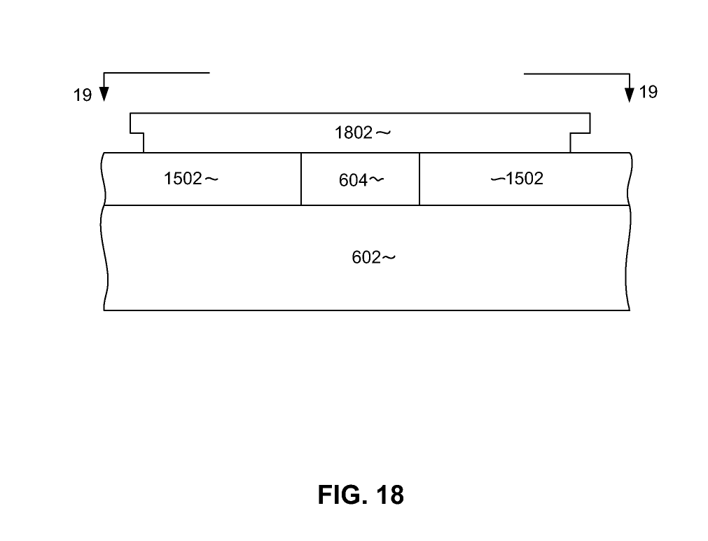

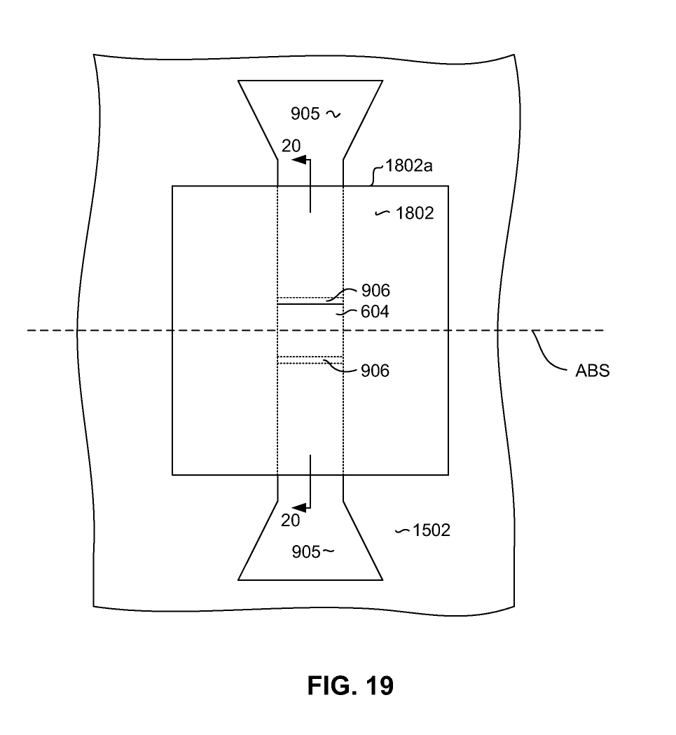

Then, with reference to FIG. 18 a third mask 1802 is formed over the sensor 604 and surrounding structure. The configuration of this mask 1802 can be better seen with reference to FIG. 19, which shows a top down view as seen from line 19-19 of FIG. 18. As can be seen in FIG. 19 the mask 1802 covers the sensor 604 and surrounding structure, but leaves the field area (area further removed from the sensor 604) uncovered. Also, the mask 1802 has an edge 1802a that defines a length of the soft bias structure 904 as measured from the air bearing surface plane ABS.

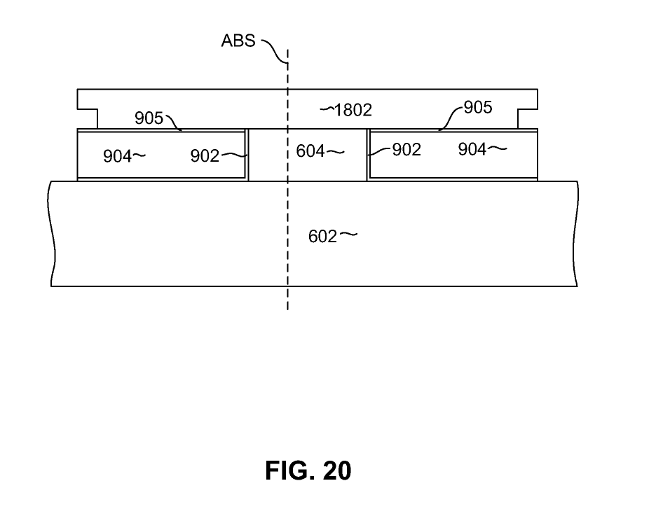

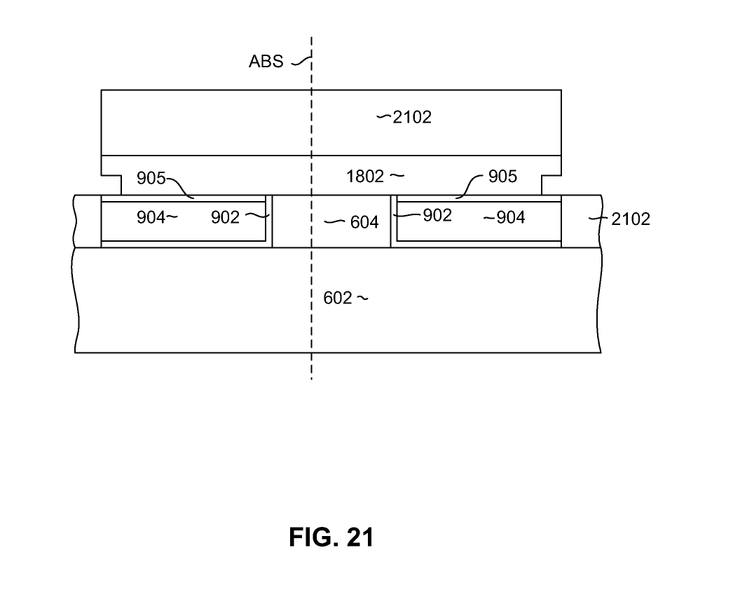

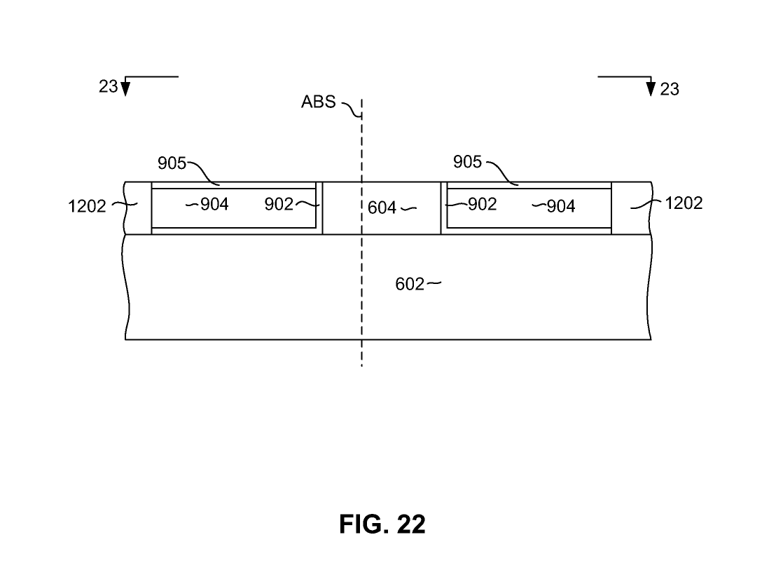

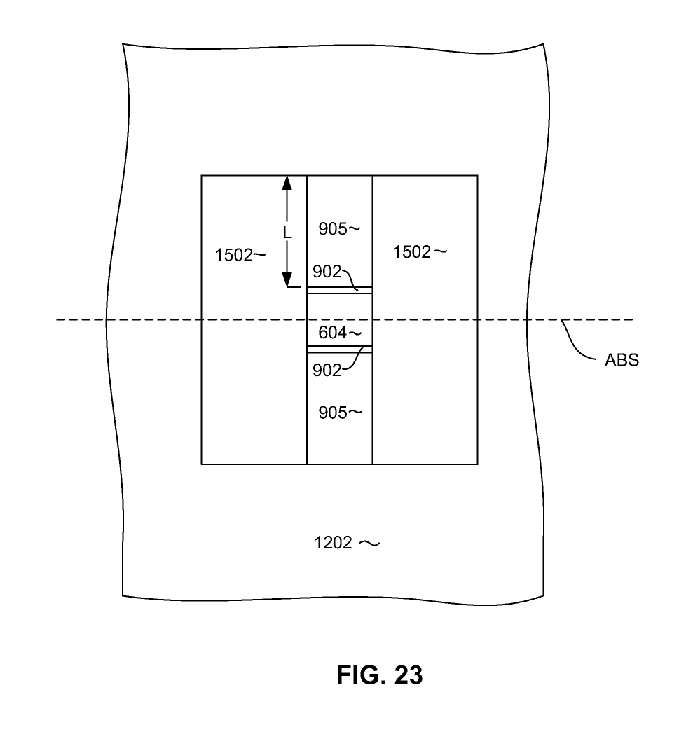

With the mask 1802 in place, a third ion milling is performed to remove material not protected by the mask 1802. This results in a structure as shown in cross section in FIG. 20, which shows a cross sectional view as seen from line 20-20 of FIG. 19. Then, with reference to FIG. 21, another non-magnetic, electrically insulating fill layer such as alumina 2102 is deposited about to the thickness of the sensor 604. A third liftoff process can be performed, leaving a structure as shown in FIG. 22. The mask 1802 is formed with an undercut as shown, which facilitates removal of the mask after deposition of the fill layer 2102. The lift-off process can include lift-off in NMP solvent. FIG. 23 shows a top down view of the structure as seen from line 23-23 of FIG. 22. As can be seen in FIG. 23, the third masking and ion milling process defines a length L of the soft magnetic bias structure as measured in a direction perpendicular to the ABS.

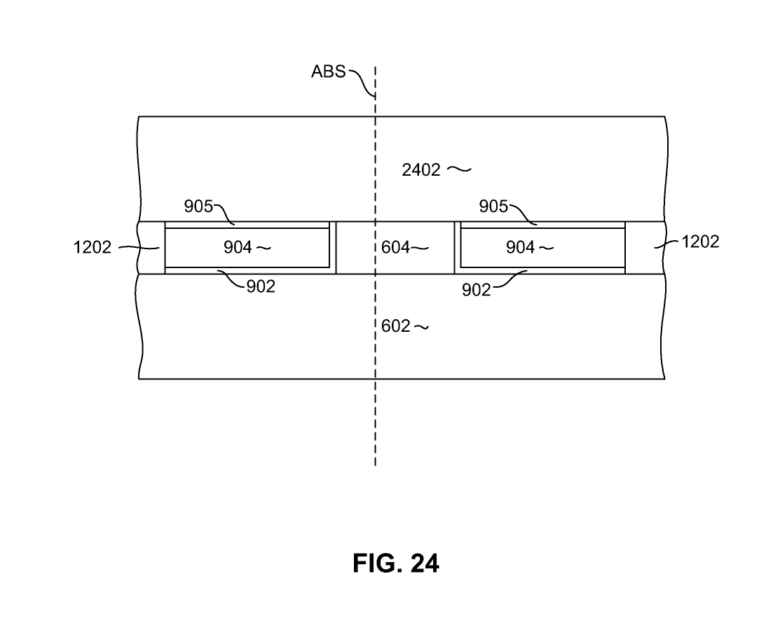

Then, with reference to FIG. 24, an upper or trailing magnetic shield 2402 can be formed by processes familiar to those skilled in the art, such as by electroplating a magnetic material such as NiFe. The magnetization of the soft magnetic bias layer 904 can be set by applying a magnetic field in a desired direction perpendicular to an air bearing surface plane (the air bearing surface not having been yet formed).

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic read sensor, comprising:
a sensor stack including first and second magnetic free layers, the sensor stack having a first edge located at an air bearing surface and a second edge opposite the first edge; and
a magnetically soft bias structure located adjacent to the second edge of the sensor stack and extending in a direction away from the air bearing surface, the magnetically soft bias structure having a shape that results in it having a magnetization that is oriented in a direction perpendicular to the air bearing surface.

2. The magnetic read sensor as in claim 1, wherein the magnetically soft bias structure has a length as measured in a direction perpendicular to the air bearing surface and has a width as measured parallel with the air bearing surface and wherein the length is greater than the width.

3. The magnetic read sensor as in claim 1, wherein:
The magnetically soft bias structure comprises a material having an intrinsic exchange length;
the magnetically soft bias structure has a width as measured parallel with the air bearing surface and a thickness measured perpendicular to the width and parallel with the air bearing surface; and
the width and thickness are less than 10 times the intrinsic exchange length.

4. The magnetic read sensor as in claim 1, wherein the magnetically soft bias layer comprises NiFe, NiFeMo, CoFe, CoNiFe or alloys thereof.

5. The magnetic read sensor as in claim 1, wherein the magnetically soft bias layer comprises NiFe having 50 to 60 atomic percent Fe or CoFe.

6. The magnetic read sensor as in claim 1, wherein the magnetically soft bias layer comprises NiFe having about 55 atomic percent Fe or CoFe.

7. The magnetic read sensor as in claim 1, wherein the magnetically soft bias structure:
comprises one or more of Co, Ni and Fe;
has a width measured parallel to the air bearing surface that is less than 40 nm; and
has a thickness measured perpendicular to the width and parallel with the air bearing surface that is less than 20 nm.

8. The magnetic read sensor as in claim 1, wherein the magnetically soft bias layer is separated from the sensor stack by a non-magnetic, electrically insulating layer.

9. The magnetic read sensor as in claim 1, further comprising a layer of antiferromagnetic material exchange coupled with the magnetically soft bias structure.

10. A magnetic data recording system, comprising:
a housing;
a magnetic media mounted within the housing;
a slider;
an actuator connected with the slider for moving the slider adjacent to a surface of the magnetic medium; and
a magnetic read sensor formed on the slider, the magnetic read sensor comprising:
a sensor stack including first and second magnetic free layers, the sensor stack having a first edge located at an air bearing surface and a second edge opposite the first edge; and
a magnetically soft bias structure located adjacent to the second edge of the sensor stack and extending in a direction away from the air bearing surface, the magnetically soft bias structure having a shape that results in it having a magnetization that is oriented in a direction perpendicular to the air bearing surface.

11. The magnetic data recording system as in claim 10, wherein the magnetically soft bias structure has a length as measured in a direction perpendicular to the air bearing surface and has a width as measured parallel with the air bearing surface and wherein the length is greater than the width.

12. The magnetic data recording system as in claim 10, wherein:
the magnetically soft bias structure comprises a material having an intrinsic exchange length;
the magnetically soft bias structure has a width as measured parallel with the air bearing surface and a thickness measured perpendicular to the width and parallel with the air bearing surface; and
the width and thickness are less than 10 times the intrinsic exchange length.

13. The magnetic data recording system as in claim 10, wherein the magnetically soft bias layer comprises NiFe, NiFeMo, CoFe, CoNiFe or alloys thereof.

14. The magnetic data recording system as in claim 10, wherein the magnetically soft bias layer comprises NiFe having 50 to 60 atomic percent Fe or CoFe.

15. The magnetic data recording system as in claim 10, wherein the magnetically soft bias layer comprises NiFe having about 55 atomic percent Fe or CoFe.

16. The magnetic data recording system as in claim 10, wherein the magnetically soft bias structure:
comprises one or more of Co, Ni and Fe;
has a width measured parallel to the air bearing surface that is less than 40 nm; and
has a thickness measured perpendicular to the width and parallel with the air bearing surface that is less than 20 nm.

17. The magnetic data recording system as in claim 10, wherein the magnetically soft bias layer is separated from the sensor stack by a non-magnetic, electrically insulating layer.

18. The magnetic data recording system as in claim 10 further comprising a layer of antiferromagnetic material exchange coupled with the magnetically soft bias structure.

19. A method for manufacturing a magnetic sensor, comprising:
forming a magnetic shield;
depositing a series of sensor layers over the shield, the series of sensor layers including first and second free magnetic layers and a non-magnetic layer sandwiched there-between;
performing a first masking and ion milling process using a mask configured to define a sensor stripe height;
depositing a soft magnetic material;
performing a second masking and ion milling process using a mask that is configured to define a sensor width; and
performing a third making and ion milling process using a mask that is configured to define a soft magnetic bias structure length.

20. The method as in claim 19, further comprising performing an annealing process to set the magnetization of the soft magnetic material in a desired direction.

21. The method as in claim 19, wherein the soft magnetic material comprises NiFe, NiFeMo, CoFe, CoNiFe or alloys thereof.

22. The method as in claim 19, wherein the soft magnetic material comprises NiFe having 50-60 atomic percent Fe or CoFe.
